(19) United States
(12) Patent Application Publication
(10) Pub. No.: US 2014/0022383 A1
(43) Pub. Date: Jan. 23, 2014

(54) SURVEILLANCE SYSTEM, IMAGE COMPRESSION SERIALIZER AND IMAGE DECOMPRESSION DESERIALIZER

(71) Applicant: TERAWINS, INC., New Taipei City (TW)

(72) Inventors: Wen-Yi HUANG, New Taipei City (TW); Hsi-Pang WEI, New Taipei City (TW); Yu-Kuang WANG, New Taipei City (TW)

(73) Assignee: TERAWINS, INC., New Taipei City (TW)

(21) Appl. No.: 13/900,168

(22) Filed: May 22, 2013

(30) Foreign Application Priority Data
Jul. 18, 2012 (TW) 101125744

(51) Int. Cl. G06T 9/00; H04N 7/18

(52) U.S. Cl. CPC G06T 9/00; H04N 7/183
USPC 348/143; 382/232

(57) ABSTRACT

A surveillance system, an image compression serializer and an image decompression deserializer are disclosed. The Surveillance System includes a video camera, a coaxial cable and a central control machine. The video camera provides a real time record and has an image compression serializer which compresses a digital image, captured by the video camera, down to a specific resolution and converts the digital image of the specific resolution into a serial format. The coaxial cable couples the image compression serializer to an image decompression deserializer of the central control machine. The digital image in the specific resolution and serial format is conveyed to the image decompression deserializer to be converted into a parallel format and decompressed to be video encoded.

### CROSS REFERENCE TO RELATED APPLICATIONS

This Application claims priority of Taiwan Patent Application No. 101125744, filed on Jul. 18, 2012, the entirety of which is incorporated by reference herein.

### BACKGROUND OF THE INVENTION

1. Field of the Invention

The present invention relates to a surveillance system, and in particular, relates to a serial transmitting module of a video camera and a serial receiving module of a central control machine (wherein the two modules may be jointly named SERDES).

2. Description of the Related Art

A surveillance system, generally, requires fairly long cables for connecting video cameras to a central control machine.

Further, cables with wider caliber are required for today's advanced video cameras, to safely convey high quality images. When upgrading the surveillance system for high resolution video surveillance, the existing cables in a building have to be replaced entirely. It is very expensive, and, large-diameter cables cost a lot.

### BRIEF SUMMARY OF THE INVENTION

A surveillance system, an image compression serializer and an image decompression deserializer are disclosed.

A surveillance system established in accordance with an exemplary embodiment of the invention comprises a video camera, a coaxial cable and a central control machine. The video camera provides a real time record and has an image compression serializer. The central control machine comprises an image decompression deserializer. The image compression serializer compresses a digital image captured by the video camera to a specific resolution and converts the digital image that has been compressed to the specific resolution into a serial format. The coaxial cable couples the image compression serializer to the image decompression deserializer to convey the digital image that is in the specific resolution and in the serial format to the image decompression deserializer. The digital image conveyed by the coaxial cable and received by the image decompression deserializer is converted into a parallel format and decompressed by the image decompression deserializer, to be video encoded.

An image compression serializer comprises a digital image decoder, an image compressor, and a serializer. By the digital image decoder, a digital image of a first data format is decoded. The image compressor receives the digital image output from the digital image decoder and compresses the digital image down to a specific resolution. The serializer is coupled to the image compressor to convert the digital image of the specific resolution into a serial format and thereby the digital image to be conveyed by the coaxial cable is in a second data format.

In another exemplary embodiment, an image decompression deserializer is shown. The image decompression deserializer is operative to recover a digital image back to a first data format. The image decompression deserializer comprises a deserializer, an image decompressor and a digital image encoder. The deserializer receives and converts a digital image of a second data format into a parallel format. Note that second data format is compatible with transmission via a coaxial cable. The image decompressor is coupled to the deserializer for data decompression. The digital image decompressed by the image decompressor is recovered by the digital image encoder back to the first data format.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a surveillance system 100 in accordance with an exemplary embodiment of the invention;

FIG. 2 is a block diagram depicting a video camera 202 and a central control machine 204 in accordance with an exemplary embodiment of the invention;

FIG. 3 is a block diagram depicting an image compression serializer 300 in accordance with an exemplary embodiment of the invention; and

FIG. 4 is a block diagram depicting an image decompression deserializer 400 in accordance with an exemplary embodiment of the invention, the image decompression deserializer 400 corresponding to the image compression serializer 300 of FIG. 3.

### DETAILED DESCRIPTION OF THE INVENTION

The following description shows several exemplary embodiments carrying out the invention. This description is made for the purpose of illustrating the general principles of the invention and should not be taken in a limiting sense. The scope of the invention is best determined by reference to the appended claims.

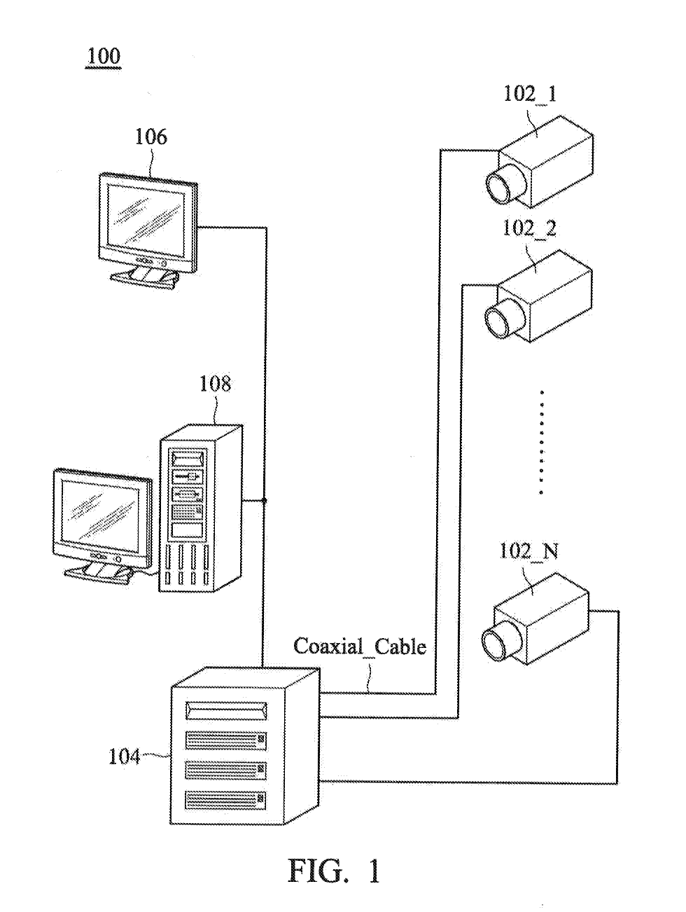

FIG. 1 is schematic diagram depicting a surveillance system 100 in accordance with an exemplary embodiment of the invention, which comprises video cameras 102_1, 102_2 . . . 102_N, a central control machine 104, a screen 106 and a computer 108. The video cameras 102_1, 102_2 . . . 102_N are connected to the central control machine 104 via coaxial cables. For example, the video camera 102_1 is coupled to the central control machine 104 via a coaxial cable Coaxial Cable. The central control machine 104 may be a digital video recorder (DVR). By the DVR, images captured by the video cameras 102_1, 102_2 . . . 102_N may be displayed on the screen 106 or transferred to the computer 108.

The video cameras 102_1, 102_2 . . . 102_N are capable of capturing high quality images. For example, the video cameras 102_1, 102_2 . . . 102_N may be SDI cameras (serial digital interface cameras), SD-SDI cameras (of 480i60 or 576i50), HD-SDI cameras (of 720P60, 720P50, 1080i60 or 1080i50), or 3G-SDI cameras (of 1080P60 or 1080P50) and so on.

Note that normal-diameter cables are adequate for implementing the coaxial cables of the disclosure (e.g. Coaxial_Cable). Any coaxial cable capable of conveying SD images (with standard definition) is adequate to implement the coaxial cable Coaxial_Cable.

To use normal-diameter coaxial cables in a high image quality surveillance system, the serial transmitting modules in the video cameras 102_1, 102_2 . . . 102_N and the serial receiving modules in the central control machine 104 are specially designed and detailed in the following paragraphs. The pair of modules may be jointly named SERDES.

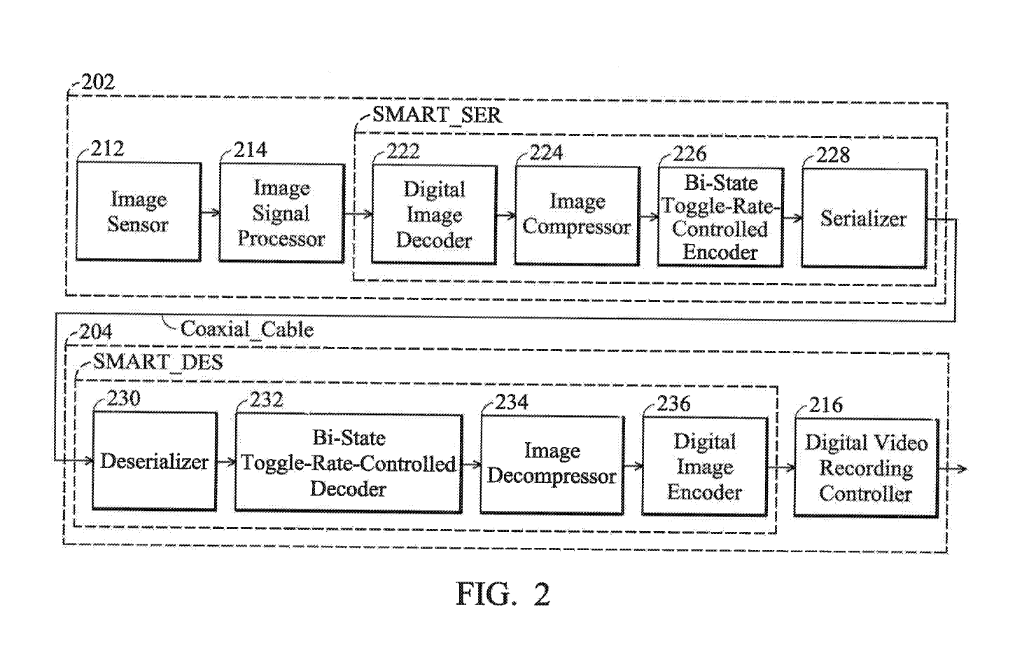

FIG. 2 is a block diagram depicting a video camera 202 and a central control machine 204. As shown, the video camera 202 and the central control machine 204 are connected by a coaxial cable Coaxial_Cable.

The video camera 202 captures images by an image sensor 212 and an image signal processor 214 and further comprises an image compression serializer SMART_SER. By the image compression serializer SMART_SER, the captured digital image may bed compressed down to a specific resolution and then converted into a serial format. The coaxial cable Coaxial_Cable couples the image compression serializer SMART_SER of the video camera 202 to the central control machine 204 and thereby the digital image in the specific resolution and the serial format is conveyed into the central control machine 204. The central control machine 204 comprises an image decompression deserializer SMART_DES by which the digital image in the specific resolution and serial format is converted into a parallel format and is decompressed for data recovery. As shown, in the central control machine 204, a digital video recording controller 216 may be coupled after the image decompression deserializer SMART_DES for the video encoder (e.g. based H.264 or other video encoding techniques). The signal which has been processed by the digital video recording controller 216 may be output by the central control machine 204 and conveyed to a screen (e.g. 106 of FIG. 1) or a computer (e.g. 108 of FIG. 1) or other video display or video storage device.

As shown in FIG. 2, the image compression serializer SMART_SER may comprise a digital image decoder 222, an image compressor 224, a bi-state toggle-rate-controlled encoder 226 and a serializer 228. The digital image captured by the video camera 202 is input to the image compression serializer SMART_SER in a first data format. The digital image in the first data format is decoded by the digital image decoder 222 and then received by the image compressor 224 to be compressed down to the specific resolution. The bi-state toggle-rate-controlled encoder 226 is coupled between the image compressor 224 and the serializer 228 to maintain a toggle rate of signals, which is optional and depends on user requirements. The serializer 228 converts the digital image of the specific resolution into a serial format, to be conveyed by the coaxial cable Coaxial_Cable in a second data format.

In the exemplary embodiment of FIG. 2, the decompression deserializer SMART_DES comprises a deserializer 230, a bi-state toggle-rate-controlled decoder 232, an image decompressor 234 and a digital image encoder 236. The digital image conveyed via the coaxial cable Coaxial_Cable in the second data format is received and converted into a parallel format by the deserializer 230. The bi-state toggle-rate-controlled decoder 232 is coupled between the deserializer 230 and the image decompressor 234 to provide a reverse calculation with respect to the bi-state toggle-rate-controlled encoder 226. The image decompressor 234 executes a decompression process. The digital image decompressed by the image decompressor 234 is further recovered back to the first data format by the digital image encoder 236 to be processed by the digital image recording controller 216.

To summarize, low priced coaxial cables (Coaxial_Cable) may be utilized in a high image quality surveillance system because of the image compressor 224 of the image compression serializer SMART_SER and the image decompressor 234 of the image decompression deserializer SMART_DES. For example, the image quality is maintained above a certain level when the bit rate of a high quality image is converted from 1.5 Gbps/3 Gbps down to 270 Mbps. Thus, inexpensive coaxial cables that can transmit signals at low bit rates may be used in a high image quality surveillance system.

The first data format may be a BT1120 data format and the second data format may be an SD-SDI data format (not intended to be limited thereto). The second data format may be any serial data format compatible with a coaxial cable. The first data format may be any parallel data format with a resolution higher the second data format.

In an exemplary embodiment, the signal conveyed via the coaxial cable Coaxial_Cable is an SD-SDI signal, To meet the minimum requirements for the bi-state toggle rate of an SD-SDI signal, the hi-state toggle-rate-controlled encoder 226 and the bi-state toggle-rate-controlled decoder 232 are designed with respect to each other, which are discussed later.

The image compressor 224 and the image decompressor 234 have various embodiments, for example, they may be implemented by PEG, H.264 or MPEG4 or any image compression/decompression technique.

The bi-state toggle-rate-controlled encoder 226 and the bi-state toggle-rate-controlled decoder 232 may be designed with respect to the JPEG (Joint Photographic Experts Group) technique, which is discussed later.

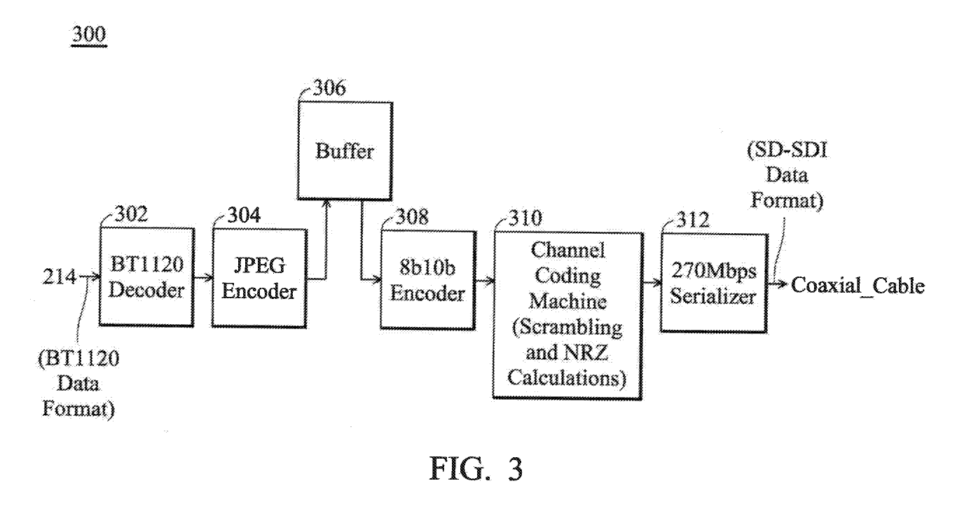

FIG. 3 is a block diagram depicting an image compression serializer 300 in accordance with an exemplary embodiment of the invention. The digital image is input to the image compression serializer 300 in a BT1120 data format and finally is output by the image compression serializer 300 in an SD-SDI data format to be conveyed by a coaxial cable Coaxial_Cable, The image compression process performed in the image compression serializer 300 is a JPEG image compression process.

As shown in FIG. 3, the image compression serializer 300 comprises a BT1120 decoder 302, a JPEG encoder 304, a buffer 306, an 8b10b encoder 308, a channel coding machine 310 and a 270 Mbps serializer 312. The digital image in the BT1120 data format is decoded by the BT1120 decoder 302 (referring to the digital image decoder 222 of FIG. 2) and then compressed by the JPEG encoder 304. With respect to the JPEG compression technique, the buffer 306 and the 8b10b encoder 308 are provided in the bi-state toggle-rate-controlled encoder (226 of FIG. 2). The data is output from the JPEG encoder 304 and buffered in the buffer 306 and then encoded by the 8b10b encoder 308 to maintain a toggle rate. Further, in regard to the SD-SDI signal transmission via the coaxial cable Coaxial_Cable, the channel coding machine 310 is provided in the bi-state toggle-rate-controlled encoder (226 of FIG. 2). The channel coding machine 310 performs scrambling and NRZ (Non-Return-to-Zero calculations. The 270 Mbps serializer 312 is for parallel-to-serial conversion, which outputs an SD-SDI signal in a bit rate of 270 Mbps to be conveyed by the coaxial cable Coaxial_Cable.

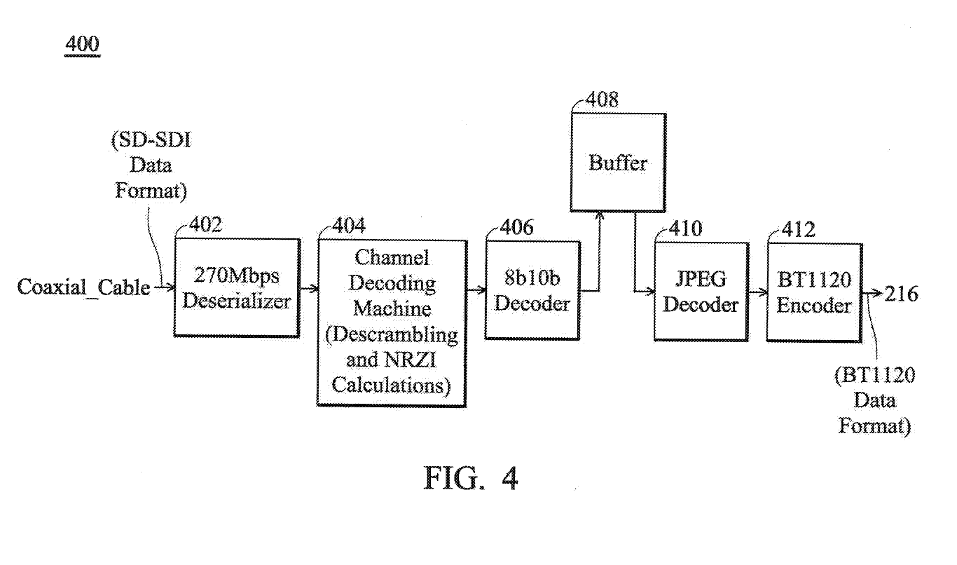

FIG. 4 is a block diagram depicting an image decompression deserializer 400 corresponding to the image compression serializer 300. The image decompression deserializer 400 comprises a 270 Mbps deserializer 402, a channel decoding machine 404, an 8b10b decoder 406, a buffer 408, a JPEG decoder 410 and a BT1120 encoder 412. The SD-SDI signal conveyed via the coaxial cable Coaxial_Cable is converted into a parallel format by the 270 Mbps deserializer 402. The channel decoding machine 404, corresponding to the channel coding machine 310, is provided to perform descrambling and NRZI (Non-Return-to-Zero-Inverted) calculations. The 8b10b decoder 406 is provided corresponding to the 8b10b encoder 308. The data decoded by the 8b10b decoder 406 is buffered by the buffer 408 and then decompressed by the JPEG decoder 410 and finally recovered back to the BT1120 data format by the BT1120 encoder 412. The channel decoding machine 404, the 8b10b decoder 406 and the buffer 408 may form the bi-state toggle-rate-controlled decoder 232 of FIG. 2. The BT1120 encoder 412 may work as the digital image encoder 236 of FIG. 2.

Note that the architecture shown in FIG. 3 and FIG. 4 are not intended to limit the scope of the invention. The image compression serializer and the image decompression deserializer should be adapted to the first and second data formats. Further, the image compression serializer and the image decompression deserializer may be implemented in two separate chips. In other exemplary embodiments, some of the disclosed function blocks may be implemented by firmware, to be executed by a processor.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A surveillance system, comprising:
a video camera, capturing images and comprising an image compression serializer, wherein a digital image captured by the video camera is compressed down to a specific resolution and converted into a serial format by the image compression serializer;
a coaxial cable, comprising a first end and a second end, wherein the first end is coupled to the image compression serializer of the video camera and thereby the digital image in the specific resolution and parallel format is conveyed via the coaxial cable; and
a central control machine, coupled to the second end of the coaxial cable and comprising an image decompression deserializer, wherein the digital image in the specific resolution and serial format is converted into a parallel format and decompressed by the image decompression deserializer.

2. The surveillance system as claimed in claim 1, wherein:
the digital image captured by the video camera is input to the image compression serializer in a first data format; and
the image compression serializer comprises:
a digital image decoder, by which the digital image in the first data format is decoded;
an image compressor, compressing the digital image received from the digital image decoder down to a specific resolution; and
a serializer coupled to the image compressor, by which the digital image in the specific resolution is converted into the serial format to be conveyed by the coaxial cable in a second data format.

3. The surveillance system as claimed in claim 2, wherein the image compression serializer further comprises:
a bi-state toggle-rate-controlled encoder, coupled between the image compressor and the serializer.

4. The surveillance system as claimed in claim 3, wherein:
the bi-state toggle-rate-controlled encoder comprises a channel coding machine performing scrambling and Non-Return-to-Zero calculations.

5. The surveillance system as claimed in claim 3, wherein:
the image compressor is a JPEG encoder; and
the bi-state toggle-rate-controlled encoder comprises an 8b10b encoder and a buffer, wherein data output from the JPEG encoder is buffered by the buffer and then input to the 8b10b encoder, and the 8b10b encoder is coupled to the serializer.

6. The surveillance system as claimed in claim 2, wherein the image decompression deserializer comprises:
a deserializer, by which the digital image in the second data format is converted into the parallel format;
an image decompressor coupled to the deserializer, performing a decompression process; and
a digital image encoder, by which the digital image decompressed by the image decompressor is recovered back to the first data format.

7. The surveillance system as claimed in claim 6, wherein the image decompression deserializer further comprises:
a bi-state toggle-rate-controlled decoder, coupled between the deserializer and the image decompressor.

8. The surveillance system as claimed in claim 7, wherein:
the bi-state toggle-rate-controlled decoder comprises a channel encoding machine performing descrambling and Non-Return-to-Zero-Inverted calculations.

9. The surveillance system as claimed in claim 7, wherein:
the image decompressor is a JPEG decoder; and
the bi-state toggle-rate-controlled decoder comprises an 8b10b decoder and a buffer, the 8b10b decoder is coupled to the deserializer, and, data output from the 8b10b decoder is buffered by the buffer and then received by the JPEG decoder.

10. The surveillance system as claimed in claim 6, wherein:
the first data format is a BT1120 data format; and
the second data format is an SD-SDI data format.

11. The surveillance system as claimed in claim 6, wherein the image compressor is a JPEG encoder.

12. An image compression serializer, comprising:
a digital image decoder, by which a digital image in a first data format is decoded;
an image compressor, receiving the digital image output from the digital image decoder and compressing the digital image down to a specific resolution; and
a serializer coupled to the image compressor to convert the digital image of the specific resolution into a serial format to be conveyed via a coaxial cable in a second data format.

13. The image compression serializer as claimed in claim 12, further comprising:
a bi-state toggle-rate-controlled encoder, coupled between the image compressor and the serializer.

14. The image compression serializer as claimed in claim 13, wherein:
the bi-state toggle-rate-controlled encoder comprises a channel coding machine performing scrambling and Non-Return-to-Zero calculations.

15. The image compression serializer as claimed in claim 13, wherein:
the image compressor is a JPEG encoder; and
the bi-state toggle-rate-controlled encoder comprises an 8b10b encoder and a buffer, wherein data output from the JPEG encoder is buffered by the buffer and then input to the 8b10b encoder, and, the 8b10b encoder is coupled to the serializer.

16. The image compression serializer as claimed in claim 12, wherein:
the first data format is a BT1120 data format; and
the second data format is an SD-SDI data format.

17. The image compression serializer as claimed in claim 12, wherein the image compressor is a JPEG encoder.

18. An image decompression deserializer recovering a digital image back to a first data format, comprising:
a deserializer, receiving the digital image that is in a second data format compatible with transmission via a coaxial cable, wherein the deserializer converts the digital image into a parallel format,
an image decompressor, coupled to the deserializer for image decompression; and
a digital image encoder, by which the digital image output from the image decompressor is recovered back to the first data format.

19. The image decompression deserializer as claimed in claim 18, further comprising:
a bi-state toggle-rate-controlled decoder, coupled between the deserializer and the image decompressor.

20. The image decompression deserializer as claimed in claim 19, wherein:
the hi-state toggle-rate-controlled decoder comprises a channel decoding machine performing descrambling and Non-Return-to-Zero-Inverted calculations.

21. The image decompression deserializer as claimed in claim 19, wherein:
the image decompressor is a JPEG decoder; and
the hi-state toggle-rate-controlled decoder comprises an 8b10b decoder and a buffer, wherein the 8b10b decoder is coupled to the deserializer, and, data output from the 8b10b decoder is buffered by the buffer and then input to the JPEG decoder.

22. The image decompression deserializer as claimed in claim 18, wherein:
the first data format is a BT1120 data format; and
the second data format is an SD-SDI data format.

23. The image decompression deserializer as claimed in claim 18, wherein the image decompressor is a JPEG decoder.
